(19) United States
(12) Patent Application Publication
(10) Pub. No.: US 2020/0342761 A1
(43) Pub. Date: Oct. 29, 2020

(54) NOTIFICATION APPARATUS AND IN-VEHICLE DEVICE

(71) Applicant: DENSO CORPORATION, Kariya-city (JP)

(72) Inventors: Mamoru HOSOKAWA, Kariya-city (JP); Takashi UEFUJI, Kariya-city (JP); Hidenori AKITA, Kariya-city (JP); Kenji MIYAKE, Kariya-City (JP); Shinya TAGUCHI, Kariya-city (JP)

(21) Appl. No.: 16/923,357

(22) Filed: Jul. 8, 2020

Related U.S. Application Data
(63) Continuation of application No. PCT/JP2019/000543, filed on Jan. 10, 2019.

(30) Foreign Application Priority Data
Jan. 10, 2018 (JP) 2018-001915

(51) Int. Cl. G08G 1/16; G06K 9/00

(52) U.S. Cl. CPC G08G 1/167; G08G 1/162; B60R 11/04; G06K 2209/21; G06K 9/00798

(57) ABSTRACT

An image captured by a camera equipped in a first vehicle during an image capture period corresponding to at least a portion of a period between a first time at which the first vehicle begins to make a lane change from a first lane to a second lane and a second time at which the first vehicle finishes making the lane change from the second lane to the first lane is acquired. The information about the image is transmitted to a second vehicle or a server.

### CROSS REFERENCE TO RELATED APPLICATION

The present application is a continuation application of International Patent Application No. PCT/JP2019/000543 filed on Jan. 10, 2019, which designated the U.S. and claims the benefit of priority from Japanese Patent Application No. 2018-001915 filed on Jan. 10, 2018. The entire disclosures of all of the above applications are incorporated herein by reference.

### TECHNICAL FIELD

The present disclosure r relates to a notification apparatus mounted on a server or in a vehicle and relates to an in-vehicle device that performs communication with the notification apparatus.

### BACKGROUND

There is a case where a target object is present ahead of a vehicle. Examples of the target object include a parked vehicle and the like. A conceivable technique teaches to allows a target object to be found using a camera mounted in a vehicle or the like.

### SUMMARY

According to an example embodiment, an image captured by a camera equipped in a first vehicle during an image capture period corresponding to at least a portion of a period between a first time at which the first vehicle begins to make a lane change from a first lane to a second lane and a second time at which the first vehicle finishes making the lane change from the second lane to the first lane is acquired. The information about the image is transmitted to a second vehicle or a server.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a configuration of a notification system;

FIG. 2 is a block diagram illustrating a functional configuration of vehicle-mounted equipment;

FIG. 3 is a block diagram illustrating a functional configuration of a server;

FIG. 4 is a block diagram illustrating a functional configuration of vehicle-mounted equipment;

FIG. 5 is a flow chart illustrating a process to be performed by the vehicle-mounted equipment;

FIG. 6A is an explanatory diagram illustrating a deviation D, while FIG. 6B is an explanatory diagram illustrating an offset angle θ;

FIG. 7 is an explanatory diagram illustrating a first position, a position Px, a position Py, a second position, a driving prohibited area, and the like;

FIG. 8 is a flow chart illustrating a process to be performed by the server;

FIG. 9 is a flow chart illustrating a process to be performed by the vehicle-mounted equipment; and

FIG. 10 is a block diagram illustrating a configuration of the notification system.

### DETAILED DESCRIPTION

As a result of detailed study conducted by the inventors, the following difficulty was found. There is a case where, between a vehicle and a target object, an object which inhibits the target object from being found is present. Examples of such an object include a large truck and the like. When an object which inhibits a target object from being found is present, the finding of the target object is delayed. As a result, it is difficult for a vehicle to avoid the target object. In an example embodiment, it is preferred to provide a notification apparatus capable of notifying a vehicle of the presence of a target object and in-vehicle device.

An example embodiment provides a notification apparatus (5, 103) including: an image acquisition unit (45) configured to acquire, during an image capture period corresponding to at least a portion of a period from a first time (ta) at which a first vehicle (9) begins to make a lane change from a first lane (83) to a second lane (85) to a second time (tb) at which the first vehicle finishes making a lane change from the second lane to the first lane, an image captured by a camera (31) included in the first vehicle; a target object recognition unit (47) configured to recognize a target object in the image acquired by the image acquisition unit; and a notification unit (61) configured to notify a second vehicle (65) located behind the first vehicle of presence of the target object recognized by the target object recognition unit.

The notification apparatus according to the example embodiment recognizes the target object in the image captured by the camera included in the first vehicle. The notification apparatus according to the example embodiment notifies the second vehicle located behind the first vehicle of the presence of the recognized target object. Accordingly, even when, e.g., an object which inhibits the target object from being found is present ahead of the second vehicle, the second vehicle is allowed to know the presence of the target object.

The notification apparatus according to the example embodiment also acquires the image captured by the camera during the image capture period. As a result, it is possible to reduce an amount of data of the image acquired by the notification apparatus according to the example embodiment. Consequently, it is possible to reduce a processing load placed on the notification apparatus according to the example embodiment by a process such as a process of recognizing the target object in the image.

The image capture period corresponds to at least a portion of the period from the first time at which the first vehicle begins to make a lane change from the first lane to the second lane to the second time at which the first vehicle finishes making a lane change from the second lane to the first lane. It is highly possible that the first vehicle made the lane changes described above in order to avoid the target object. Accordingly, it is highly possible that the image captured by the camera during the image capture period represents the target object. The notification apparatus according to the example embodiment recognizes the target object in the image captured by the camera during the image capture period. Therefore, it is highly possible that the notification apparatus can recognize the target object.

Another example embodiment provides an in-vehicle device (3) mounted in a mounting vehicle (9) including a camera (31), the in-vehicle device including: a lane change detection unit configured to detect a lane change made by the mounting vehicle; and a transmission unit configured to transmit, to a server, an image captured by the camera (31) during an image capture period corresponding to at least a portion of a period from a first time (ta) at which the mounting vehicle begins to make a lane change from a first lane (83) to a second lane (85) to a second time (tb) at which the mounting vehicle finishes making a lane change from the second lane to the first lane.

By using the image transmitted by the in-vehicle device according to the example embodiment, the server can, e.g., recognize the presence of the target object and produce information representing the presence of the target object. The other vehicle can, e.g., receive the information representing the presence of the target object via the server.

Still another example embodiment provides in-vehicle device (7) mounted in a mounting vehicle (65), the in-vehicle device including: an information reception unit (71) configured to receive, via a server (5), information representing presence of a target object recognized by the server on the basis of an image captured by a camera (31) included in another vehicle (9) during an image capture period corresponding to at least a portion of a period from a first time (ta) at which the other vehicle begins to make a lane change from a first lane (83) to a second lane (85) to a second time (tb) at which the other vehicle finishes making a lane change from the second lane to the first lane; and a control unit (76) configured to control the mounting vehicle on the basis of the information representing the presence of the target object.

The in-vehicle device according to the example embodiment can receive the information representing the presence of the target object via the server and control the mounting vehicle on the basis of the information.

Referring to the drawings, a description will be given of exemplary embodiments of the present disclosure.

### First Embodiment

1. Configuration of Notification System 1

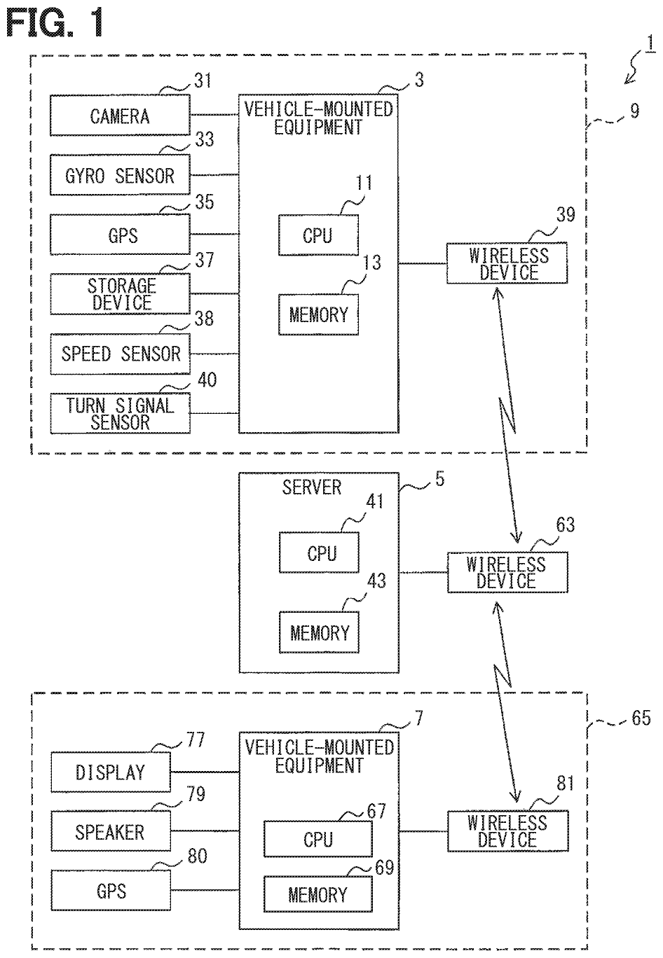

A configuration of a notification system 1 will be described on the basis of FIGS. 1 to 4. As illustrated in FIG. 1, the notification system 1 includes vehicle-mounted equipment 3, a server 5, and vehicle-mounted equipment 7. The server 5 corresponds to a notification apparatus.

The vehicle-mounted equipment 3 is mounted in a first vehicle 9. For the vehicle-mounted equipment 3, the first vehicle 9 corresponds to a mounting vehicle. The vehicle-mounted equipment 3 includes a microcomputer including a CPU 11 and a semiconductor memory (hereinafter referred to as the memory 13) such as, e.g., a RAM or a ROM. Each of functions of the vehicle-mounted equipment 3 is implemented by the CPU 11 by executing a program stored in a non-transitory tangible recording medium. In this example, the memory 13 corresponds to the non-transitory tangible recording medium in which the program is stored. In addition, through the execution of the program, a method corresponding to the program is implemented. Note that the vehicle-mounted equipment 3 may include one microcomputer or a plurality of microcomputers.

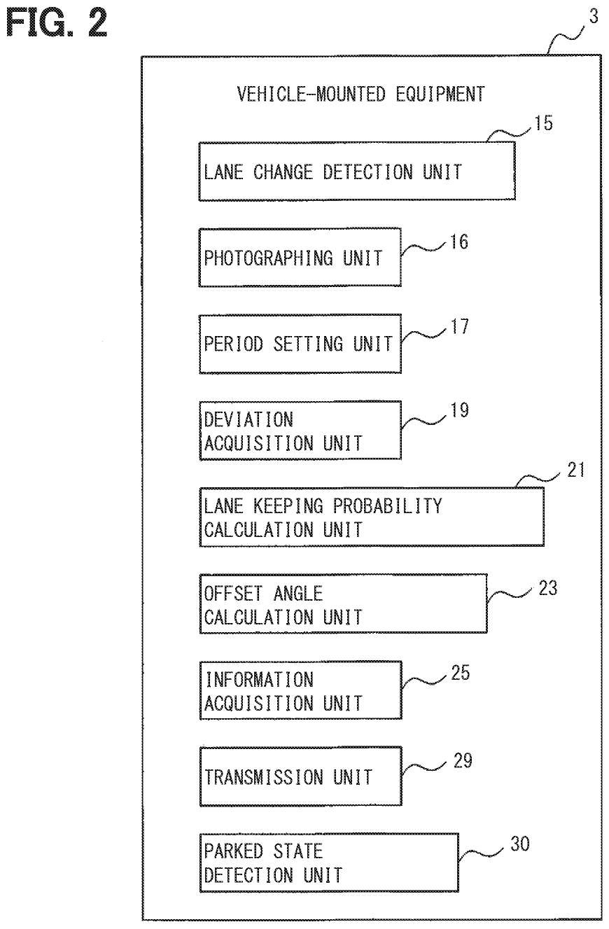

As illustrated in FIG. 2, the vehicle-mounted equipment 3 includes a lane change detection unit 15, a photographing unit 16, a period setting unit 17, a deviation acquisition unit 19, a lane keeping probability calculation unit 21, an offset angle calculation unit 23, an information acquisition unit 25, a transmission unit 29, and a parked state detection unit 30.

A method of implementing each of functions of the individual units included in the vehicle-mounted equipment 3 is not limited to that using a software item. Any or all of the functions may also be implemented using one hardware item or a plurality of hardware items. For example, when any of the functions mentioned above is implemented using an electronic circuit as a hardware item, the electronic circuit may also be implemented by a digital circuit, an analog circuit, or a combination of the digital circuit and the analog circuit.

As illustrated in FIG. 1, the first vehicle 9 includes, in addition to the vehicle-mounted equipment 3, a camera 31, a gyro sensor 33, a GPS 35, a storage device 37, a speed sensor 38, a wireless device 39, and a turn signal sensor 40. The camera 31 photographs an environment around the first vehicle 9 to generate an image. The camera 31 can generate a moving image. Each of frames included in the moving image corresponds to the image.

The gyro sensor 33 detects an angular speed of the first vehicle 9 in a yaw direction. The GPS 35 acquires positional information of the first vehicle 9. The positional information acquired by the GPS 35 is positional information represented by a latitude and a longitude. In other words, the positional information acquired by the GPS 35 is information representing a position at absolute coordinates (hereinafter referred to as the absolute position).

The storage device 37 stores map information. The map information includes information such as a road type at each position and a direction of travel on a road. Examples of the road type include an intersection, a straight road, a T-junction, a general road, a limited highway, and the like. The speed sensor 38 detects a speed of the first vehicle 9. The wireless device 39 is capable of wireless communication with a wireless device 63 described later. The turn signal sensor 40 detects a state of a turn signal in the first vehicle 9. The state of the turn signal includes a right-turn-signal ON state, a left-turn-signal ON state, and a right/left-turn signal OFF state.

The server 5 is fixedly disposed at a predetermined place. The server 5 includes a microcomputer including a CPU 41 and a semiconductor memory (hereinafter referred to as the memory 43) such as, e.g., a RAM or a ROM. Each of functions of the server 5 is implemented by the CPU 41 by executing a program stored in a non-transitory tangible recording medium. In this example, the memory 43 corresponds to the non-transitory tangible recording medium in which the program is stored. In addition, through the execution of the program, a method corresponding to the program is implemented. Note that the server 5 may include one microcomputer or a plurality of microcomputers.

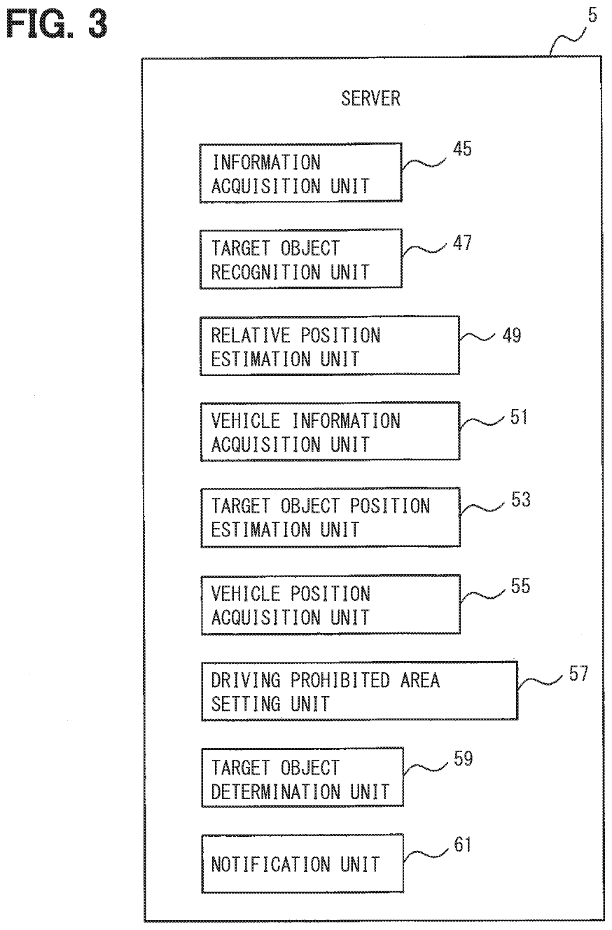

As illustrated in FIG. 3, the server 5 includes an information acquisition unit 45, a target object recognition unit 47, a relative position estimation unit 49, a vehicle information acquisition unit 51, a target object position estimation unit 53, a vehicle position acquisition unit 55, a driving prohibited area setting unit 57, a target object determination unit 59, and a notification unit 61. The information acquisition unit 45 corresponds to an image acquisition unit.

A method of implementing each of functions of the individual units included in the server 5 is not limited to that using a software item. Any or all of the functions may also be implemented using one hardware item or a plurality of hardware items. For example, when any of the functions mentioned above is implemented using an electronic circuit as a hardware item, the electronic circuit may also be implemented by a digital circuit, an analog circuit, or a combination of the digital circuit and the analog circuit.

As illustrated in FIG. 1, the server 5 is connected to the wireless device 63. The wireless device 63 is capable of wireless communication with each of the wireless device 39 and a wireless device 81 described later.

The vehicle-mounted equipment 7 is mounted in a second vehicle 65. For the vehicle-mounted equipment 7, the second vehicle 65 corresponds to the mounting vehicle. For the vehicle-mounted equipment 7, the first vehicle 9 corresponds to another vehicle. The vehicle-mounted equipment 7 includes a microcomputer including a CPU 67 and a semiconductor memory (hereinafter referred to as the memory 69) such as, e.g., a RAM or a ROM. Each of functions of the vehicle-mounted equipment 7 is implemented by the CPU 67 by executing a program stored in a non-transitory tangible recording medium. In this example, the memory 69 corresponds to the non-transitory tangible recording medium in which the program is stored. In addition, through the execution of the program, a method corresponding to the program is implemented. Note that the vehicle-mounted equipment 7 may include one microcomputer or a plurality of microcomputers.

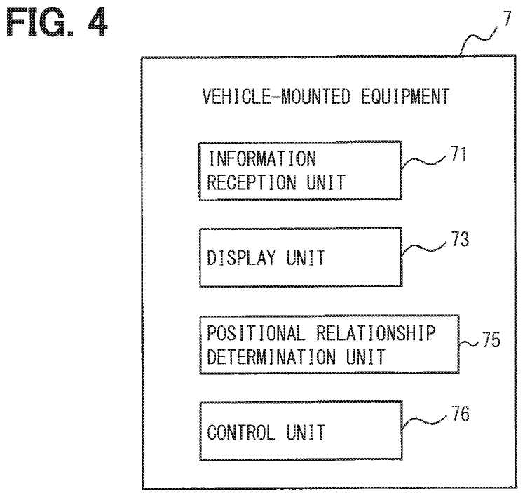

As illustrated in FIG. 4, the vehicle-mounted equipment 7 includes an information reception unit 71, a display unit 73, a positional relationship determination unit 75, and a control unit 76. A method of implementing each of functions of the individual units included in the vehicle-mounted equipment 7 is not limited to that using a software item. Any or all of the functions may also be implemented using one hardware item or a plurality of hardware items. For example, when any of the functions mentioned above is implemented using an electronic circuit as a hardware item, the electronic circuit may be implemented by a digital circuit, an analog circuit, or a combination of the digital circuit and the analog circuit.

As illustrated in FIG. 1, the second vehicle 65 includes, in addition to the vehicle-mounted equipment 7, a display 77, a speaker 79, a GPS 80, and the wireless device 81. The display 77 and the speaker 79 are provided in a vehicle compartment of the second vehicle 65. The display 77 is capable of displaying an image. The speaker 79 is capable of outputting voice. The GPS 80 acquires positional information representing an absolute position of the second vehicle 65. The wireless device 81 is capable of wireless communication with the wireless device 63.

2. Process to be Performed by Vehicle-Mounted Equipment 3

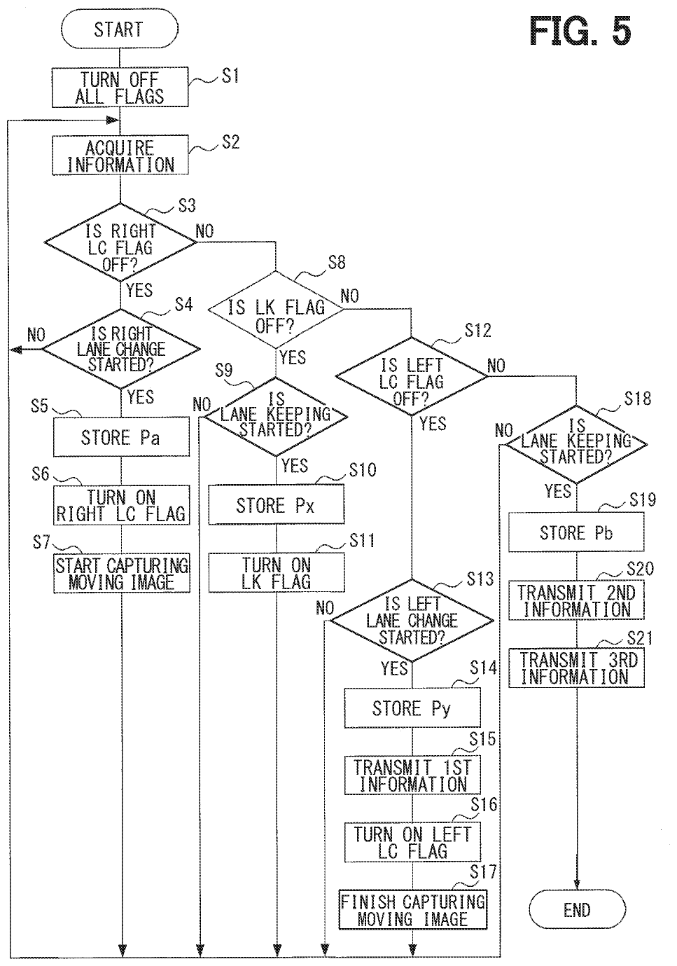

A process to be performed by the vehicle-mounted equipment 3 will be described on the basis of FIGS. 5 to 7. In Step 1 in FIG. 5, the lane change detection unit 15 turns OFF each of a right LC flag, an LK flag, and a left LC flag. These flags will be described later.

In Step 2, the information acquisition unit 25 acquires various information. The acquired information includes the absolute position of the first vehicle 9, the speed of the first vehicle 9, an azimuth angle of the first vehicle 9, the road type at the position of the first vehicle 9, the state of the turn signal in the first vehicle 9, and the like. The azimuth angle corresponds to a direction from a rear side to a front side of the vehicle.

The information acquisition unit 25 acquires the absolute position of the first vehicle 9 using the GPS 35. The information acquisition unit 25 acquires the speed of the first vehicle 9 using the speed sensor 38. The information acquisition unit 25 repetitively measures an angular speed of the first vehicle 9 in the yaw direction using the gyro sensor 33 and integrates the angular speed to acquire the azimuth angle of the first vehicle 9. The information acquisition unit 25 reads the road type at the position of the first vehicle 9 from the map information stored in the storage device 37. The information acquisition unit 25 acquires the state of the turn signal in the first vehicle 9 using the turn signal sensor 40.

In Step 3, the lane change detection unit 15 determines whether or not the right LC flag is OFF. When the right LC flag is OFF, the present process advances to Step 4. When the right LC flag is ON, the present process advances to Step 8.

In Step 4, the lane change detection unit 15 determines whether or not a right lane change is started. The right lane change is a lane change from a first lane 83 to a second lane 85 illustrated in FIG. 7.

The lane change detection unit 15 determines that the right lane change is started when all requirements J1 to J4 shown below are satisfied. Meanwhile, the lane change detection unit 15 determines that the right lane change is not started when at least one of the requirements J1 to J4 is not satisfied.

(J1) The lane keeping probability is equal to or lower than a threshold TK1 set in advance.

(J2) The offset angle θ is equal to or larger than a threshold Tθ set in advance.

(J3) The road type acquired in immediately previous Step 2 described above is not the intersection.

(J4) The state of the turn signal acquired in immediately previous Step 2 described above is the right-turn-signal ON state.

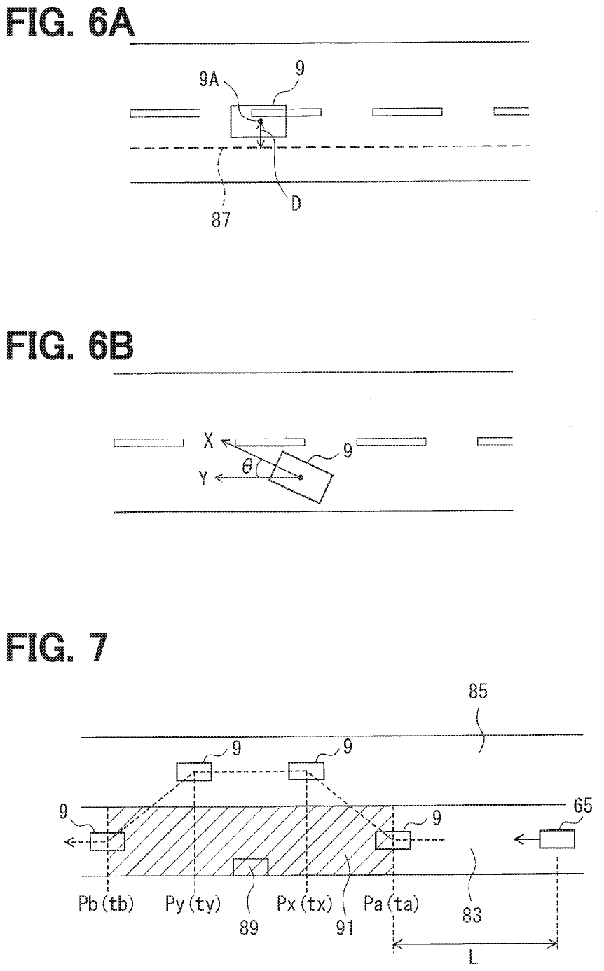

The lane keeping probability is a probability that the first vehicle 9 keeps a current lane. The lane keeping probability is calculated as follows. As illustrated in FIG. 6A, the deviation acquisition unit 19 acquires a deviation D in a lateral direction between a center position 87 in the lane in which the first vehicle 9 is present and the position of a center 9A of the first vehicle 9. The lateral direction is a direction perpendicular to the direction of travel on the road. Then, the lane keeping probability calculation unit 21 inputs the deviation D to a function stored in advance in the memory 13 to obtain the lane keeping probability. The function calculates a higher lane keeping probability as the deviation D is smaller.

As illustrated in FIG. 6B, the offset angle θ is an angle formed between an azimuth angle X of the first vehicle 9 and a direction of travel Y in the lane in which the first vehicle 9 is present. The offset angle calculation unit 23 calculates the offset angle θ using the azimuth angle X of the first vehicle 9 acquired in Step 2 described above and the direction of travel Y read from the map information.

When the right lane change is started, the present process advances to Step 5. When the right lane change is not started yet, the present process returns to Step 2.

In Step 5, the lane change detection unit 15 determines the current absolute position of the first vehicle to be a first position Pa and stores the first position Pa. As illustrated in FIG. 7, the first position Pa is the absolute position of the first vehicle 9 at a first time ta at which the first vehicle 9 begins to make a lane change from the first lane 83 to the second lane 85.

In Step 6, the lane change detection unit 15 turns ON the right LC flag.

In Step 7, the period setting unit 17 sets an image capture period beginning at the first time ta. The image capture period lasts till a time ty described later. During the image capture period, the photographing unit 16 captures a moving image using the camera 31. Accordingly, the capturing of the moving image is started at the first time ta. After Step 7, the present process returns to Step 2.

In Step 8, the lane change detection unit 15 determines whether or not the LK flag is OFF. When the LK flag is OFF, the present process advances to Step 9. When the LK flag is ON, the present process advances to Step 12.

In Step 9, the lane change detection unit 15 determines whether or not lane keeping is started. The lane keeping in Step 9 corresponds to keeping of the second lane 85 illustrated in FIG. 7. The lane change detection unit 15 determines that the lane keeping is started when the lane keeping probability is equal to or higher than a threshold TK2 set in advance. When the lane keeping probability is equal to or higher than the threshold TK2, the present process advances to Step 10. The threshold TK2 is larger than the threshold TK1.

Meanwhile, when the lane keeping probability is lower than the threshold TK2, the lane change detection unit 15 determines that the lane keeping is not started, and the right lane change is continuing. When the lane keeping probability is lower than the threshold TK2, the present process returns to Step 2.

In Step 10, the lane change detection unit 15 determines the current absolute position of the first vehicle 9 to be the position Px and stores the position Px. As illustrated in FIG. 7, the position Px is the absolute position of the first vehicle 9 at a time tx at which the first vehicle 9 completes the lane change from the first lane 83 to the second lane 85 and begins to keep the second lane 85.

In Step 11, the lane change detection unit 15 turns ON the LK flag. After Step 11, the present process returns to Step 2.

In Step 12, the lane change detection unit 15 determines whether or not the left LC flag is OFF. When the left LC flag is OFF, the present process advances to Step 13. When the left LC flag is ON, the present process advances to Step 18.

In Step 13, the lane change detection unit 15 determines whether or not a left lane change is started. The left lane change is a lane change from the second lane 85 to the first lane 83 illustrated in FIG. 7.

The lane change detection unit 15 determines that the left lane change is started when all the requirements J1 to J3 and J5 shown below are satisfied. Meanwhile, the lane change detection unit 15 determines that the left lane change is not started when at least one of the requirements J1 to J3 and J5 is not satisfied.

(J1) The lane keeping probability is equal to or lower than the threshold TK1 set in advance.

(J2) The offset angle θ is equal to or larger than the threshold Tθ set in advance.

(J3) The road type acquired in immediately previous Step 2 described above is not the intersection.

(J5) The state of the turn signal acquired in immediately previous Step 2 described above is the left-turn-signal ON state.

When the left lane change is started, the present process advances to Step 14. When the left lane change is not started yet, the present process returns to Step 2.

In Step 14, the lane change detection unit 15 determines the current absolute position of the first vehicle 9 to be a position Py and stores the position Py. As illustrated in FIG. 7, the position Py is the absolute position of the first vehicle 9 at the time ty at which the first vehicle 9 begins to make the lane change from the second lane 85 to the first lane 83.

In Step 15, the transmission unit 29 transmits first information using the wireless device 39. The first information is the information including the first position Pa. As will be described later, the server 5 receives the first information.

In Step 16, the lane change detection unit 15 turns ON the left LC flag.

In Step 17, the period setting unit 17 ends the image capture period at the time ty. The photographing unit 16 finishes capturing the moving image at the time ty. Note that the image capture period corresponds to a portion of a period from the first time ta to a second time tb described later. After Step 17, the present process returns to Step 2.

In Step 18, the lane change detection unit 15 determines whether or not lane keeping is started. The lane keeping in present Step 18 corresponds to keeping of the first lane 83 illustrated in FIG. 7. The lane change detection unit 15 determines that the lane keeping is started when the lane keeping probability is equal to or higher than the threshold TK2 set in advance. When the lane keeping probability is equal to higher than the threshold TK2, the present process advances to Step 19.

Meanwhile, when the lane keeping probability is lower than the threshold TK2, the lane change detection unit 15 determines that the lane keeping is not started, and the left lane change is continuing. When the lane keeping probability is lower than the threshold TK2, the present process returns to Step 2.

In Step 19, the lane change detection unit 15 determines the current absolute position of the first vehicle 9 to be a second position Pb and stores the second position Pb. As illustrated in FIG. 7, the second position Pb is the absolute position of the first vehicle 9 at the second time tb at which the first vehicle 9 begins to keep the second lane 85.

In Step 20, the transmission unit 29 transmits second information using the wireless device 39. The second information includes the first position Pa, the position Px, the position Py, and the second position Pb. As will be described later, the server 5 receives the second information.

In Step 21, the transmission unit 29 transmits third information using the wireless device 39. The third information includes the moving image captured during the image capture period. The third information further includes the absolute position and the azimuth angle of the first vehicle 9 when each of frames included in the moving image is captured. In the third information, each of the frames is associated with the absolute position and the azimuth angle of the first vehicle 9 when the frame is captured. As will be described later, the server 5 receives the third information. After Step 21, the present process is ended.

The parked state detection unit 30 detects that the first vehicle 9 is parked as a parked vehicle on a road on the basis of respective signals from the GPS 35, the speed sensor 38, the turn signal sensor 40, the gyro sensor 33, and a parking brake not shown. The transmission unit 29 transmits the parking of the first vehicle 9 as the parked vehicle on the road as well as the position of the first vehicle 9 to the server 5 using the wireless device 39. Note that information representing the parking of the first vehicle 9 as the parked vehicle on the road as well as the position of the first vehicle 9 is referred to hereinbelow as parked vehicle information. After Step 21, the present process is ended.

3. Process to be Performed by Server 5

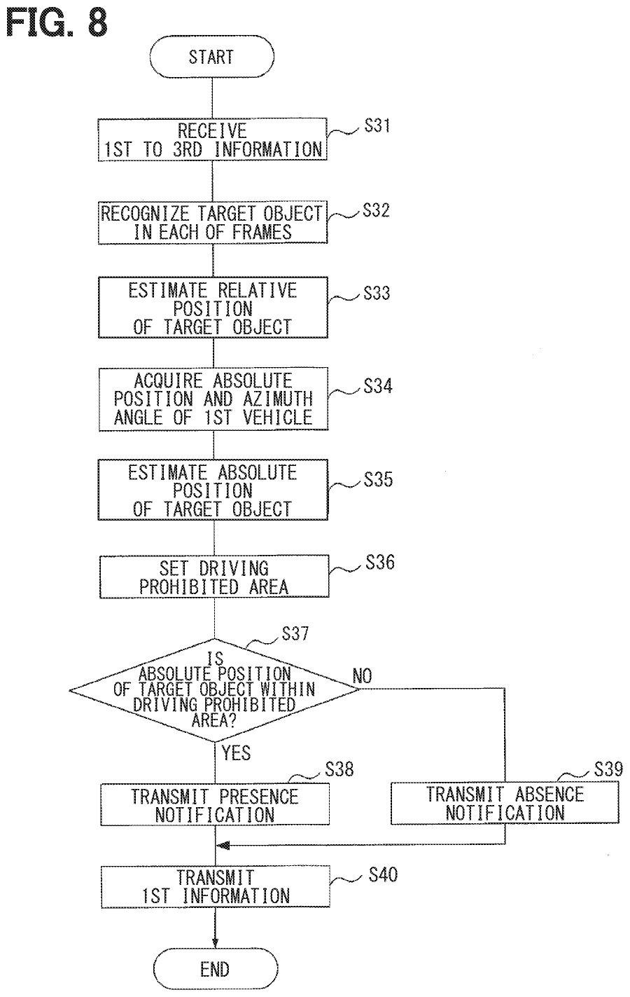

A process to be performed by the server 5 will be described on the basis of FIGS. 7 and 8. In Step 31 in FIG. 8, the information acquisition unit 45 receives the first information, the second information, the third information, and the parked vehicle information using the wireless device 63. The first information, the second information, the third information, and the parked vehicle information are transmitted from the vehicle-mounted equipment 3.

In Step 32, the target object recognition unit 47 uses a known image recognition technique to recognize the target object in the frames. The frames are included in the moving image included in the third information. As the target object, for example, a parked vehicle 89 illustrated in FIG. 7 or the like can be listed. The target object recognition unit 47 recognizes the target object in each of the frames.

In Step 33, the relative position estimation unit 49 estimates a relative position of the target object recognized in Step 32 described above, which is based on the position of the first vehicle 9. The relative position estimation unit 49 can estimate the relative position of the target object on the basis of a position, a size, and the like of the target object in each of the frames. The relative position estimation unit 49 estimates the relative position of the target object in each of the frames.

In Step 34, the vehicle information acquisition unit 51 acquires, from the third information received in Step 31 described above, the absolute position and the azimuth angle of the first vehicle 9 when each of the frames is captured. The vehicle information acquisition unit 51 acquires, for each of the frames, the absolute position and the azimuth angle of the first vehicle 9.

In Step 35, the target object position estimation unit 53 estimates the absolute position of the target object on the basis of each of the absolute position and the azimuth angle of the first vehicle 9 acquired in Step 34 described above and the relative position of the target object estimated in Step 33 described above. The target object position estimation unit 53 estimates, for each of the frames, the absolute position of the target object.

In Step 36, the driving prohibited area setting unit 57 sets a driving prohibited area on the basis of each of the first position Pa and the second position Pb included in the second information received in Step 31 described above and the parked vehicle information. As illustrated in FIG. 7, a driving prohibited area 91 corresponds to a range from the first position Pa to the second position Pb in the direction of travel on the road. In the lateral direction, the driving prohibited area 91 corresponds to the entire first lane 83 in which the target object such as the parked vehicle 89 is present.

In Step 37, the target object determination unit 59 determines whether or not the absolute position of the target object estimated in Step 35 described above is within the driving prohibited area set in Step 36 described above. When the absolute position of the target object varies from one frame to another, the target object determination unit 59 calculates an average value of the absolute positions of the target object in all the frames and determines whether or not the average value is within the driving prohibited area.

When the absolute position of the target object is within the driving prohibited area, the present process advances to Step 38. When the absolute position of the target object is not within the driving prohibited area, the present process advances to Step 39.

In Step 38, the notification unit 61 transmits a presence notification using the wireless device 63. The presence notification is information including information representing the presence of the target object within the driving prohibited area, the first position Pa, the position Px, the position Py, the second position Pb, the position of the driving prohibited area, and the like. As will be described above, the vehicle-mounted equipment 7 receives the presence notification.

In Step 39, the notification unit 61 transmits an absence notification using the wireless device 63. The absence notification is information including information representing the absence of the target object within the driving prohibited area, the first position Pa, the position Px, the position Py, and the second position Pb. As will be described later, the vehicle-mounted equipment 7 receives the absence notification.

In Step 40, the notification unit 61 transmits the first information using the wireless device 63. As will be described later, the vehicle-mounted equipment 7 receives the first information.

4. Process to be Performed by Vehicle-Mounted Equipment 7

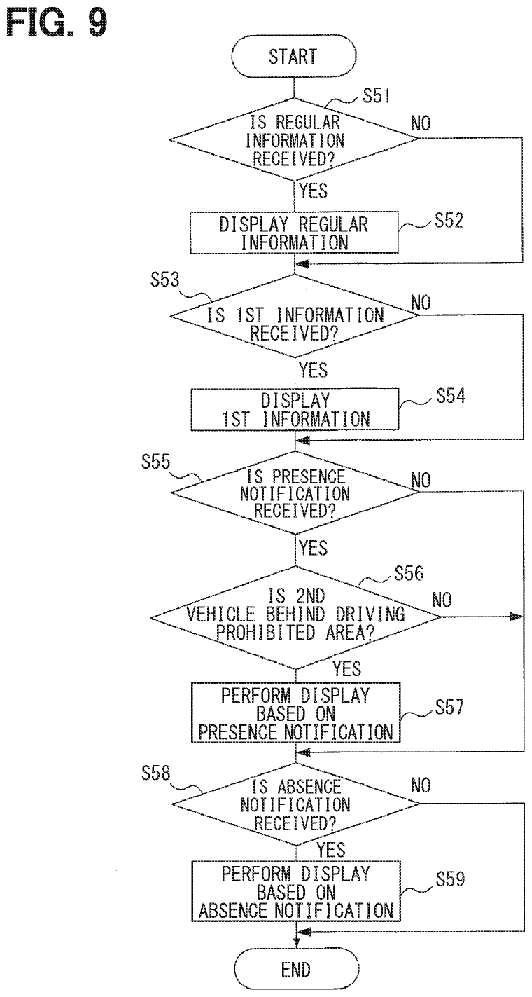

A process to be performed by the vehicle-mounted equipment 7 will be described on the basis of FIGS. 7 and 9. In Step S1 in FIG. 9, the information reception unit 71 determines whether or not regular information is received by the wireless device 81. The regular information is information regularly transmitted by the server 5. When the regular information is received, the present process advances to Step S2. When the regular information is not received, the present process advances to Step S3.

In Step S2, the display unit 73 displays details of the regular information on the display 77.

In Step S3, the information reception unit 71 determines whether or not the first information is received by the wireless device 81. The first information is the information transmitted from the server 5. When the first information is received, the present process advances to Step S4. When the first information is not received, the present process advances to Step S5.

In Step S4, the display unit 73 displays details of the first information on the display 77.

In Step S5, the information reception unit 71 determines whether or not the presence notification is received by the wireless device 81. The presence information is the information transmitted from the server 5. When the presence notification is received, the present process advances to Step S6. When the presence notification is not received, the present process advances to Step S8.

In Step S6, the positional relationship determination unit 75 acquires positional information representing the absolute position of the second vehicle 65 using the GPS 80. In addition, the positional relationship determination unit 75 reads the positional information of the driving prohibited area 91 included in the presence notification. Then, the positional relationship determination unit 75 determines whether or not the absolute position of the second vehicle 65 is behind the driving prohibited area 91 and a distance L between the first position Pa and the second vehicle 65 is equal to or smaller than a predetermined threshold as illustrated in FIG. 7. When the absolute position of the second vehicle 65 is behind the driving prohibited area 91 and the distance L is equal to or smaller than the threshold, the present process advances to Step S7. Otherwise, the present process advances to Step S8.

In Step S7, the display unit 73 shows, on the display 77, details of display based on the presence notification. The details of the display include the presence of the target object ahead of the second vehicle 65, the distance from the second vehicle 65 to the first position Pa, and the like.

In Step S8, the information reception unit 71 determines whether or not the absence notification is received by the wireless device 81. The absence notification is the information transmitted from the server 5. When the absence notification is received, the present process advances to Step S9. When the absence notification is not received, the present process is ended.

In Step S9, the display unit 73 shows, on the display 77, details of display based on the absence notification. The details of the display include the absence of the target object within the driving prohibited area and the like. Note that, when the presence notification is received, the control unit 76 may also control the second vehicle 65 on the basis of the presence notification. Examples of the control include vehicle deceleration, vehicle stop, vehicle steering, and the like.

5. Effects Achieved by Vehicle-Mounted Equipment 3 and Server 5

(1A) The first vehicle 9 includes the camera 31. The server 5 recognizes the target object in the moving image captured by the camera 31. The server 5 notifies the second vehicle 65 located behind the first vehicle 9 of the presence of the recognized target object. Accordingly, even when, e.g., an object which inhibits the target object from being found is present ahead of the second vehicle 65, the second vehicle 65 is allowed to know the presence of the target object.

The server 5 also acquires the moving image captured by the camera 31 during the image capture period. This can reduce an amount of data of the acquired moving image. As a result, it is possible to reduce a processing load placed by a process of recognizing the target object in the moving image or the like.

The image capture period corresponds to at least a portion of a period from the first time to at which the first vehicle 9 begins to make a lane change from the first lane 83 to the second lane 85 to the second time tb at which the first vehicle 9 finishes making a lane change from the second lane 85 to the first lane 83. It is highly possible that the first vehicle 9 made the lane changes described above in order to avoid the target object. Accordingly, it is highly possible that the moving image captured by the camera 31 during the image capture period represents the target object. Since the server 5 recognizes the target object in the moving image captured by the camera 31 during the image capture period, it is highly possible that the camera 31 can recognize the target object.

(1B) The server 5 acquires the absolute position and the azimuth angle of the first vehicle 9 when the moving image is captured. The server 5 also estimates the relative position of the target object based on the absolute position of the first vehicle 9 on the basis of the moving image. The server 5 further estimates the absolute position of the target object on the basis of each of the absolute position and the azimuth angle of the first vehicle 9 and the relative position of the target object.

The server 5 acquires the first position Pa and the second position Pb on the basis of the result of the detection by the lane change detection unit 15. Then, the server 5 sets the driving prohibited area on the basis of the first position Pa and the second position Pb. The server 5 determines whether or not the absolute position of the target object is within the driving prohibited area. The server 5 notifies the second vehicle 65 of the presence of the target object on condition that the absolute position of the target object is within the driving prohibited area.

Consequently, even when recognizing the target object outside the driving prohibited area, the server 5 does not notify the second vehicle 65 of the presence of the target object. As a result, it is possible to inhibit the server 5 from transmitting a less necessary notification to the second vehicle 65.

(1C) The vehicle-mounted equipment 3 detects the lane change made of the first vehicle 9 to determine the first time ta and set the image capture period beginning at the first time ta. Accordingly, it is possible to easily and precisely set the image capture period.

(1D) The vehicle-mounted equipment 3 calculates the lane keeping probability and the offset angle θ and detects that the first vehicle 9 begins to make a lane change. Accordingly, it is possible to easily and precisely detect the lane change made by the first vehicle 9.

(1E) The vehicle-mounted equipment 3 detects that the first vehicle 9 begins to make a lane change on the basis of the road type and the turn signal state in addition to the lane keeping probability and the offset angle θ. Accordingly, it is possible to easily and precisely detect the lane change made by the first vehicle 9. By particularly using the road type, it is possible to inhibit erroneous recognition of a right/left turn at the intersection as a lane change.

(1F) The vehicle-mounted equipment 3 causes the parked state detection unit 30 to detect that the first vehicle 9 is parked as a parked vehicle on the road. The vehicle-mounted equipment 3 produces the parked vehicle information representing the parking of the first vehicle 9 as the parked vehicle on the road and the position of the first vehicle 9 and transmits the parked vehicle information to the server 5. The server 5 can notify the second vehicle 65 of even information on the first vehicle 9 parked as the parked vehicle in addition to the parked vehicle recognized on the basis of the camera image received from the vehicle-mounted equipment 3.

### Second Embodiment

1. Difference from First Information

A basic configuration of a second embodiment is the same as that of the first embodiment, and accordingly a description will be given below of a difference from the first embodiment. Since the same reference numerals used in the first embodiment denote the same components, refer to the previous description of the components.

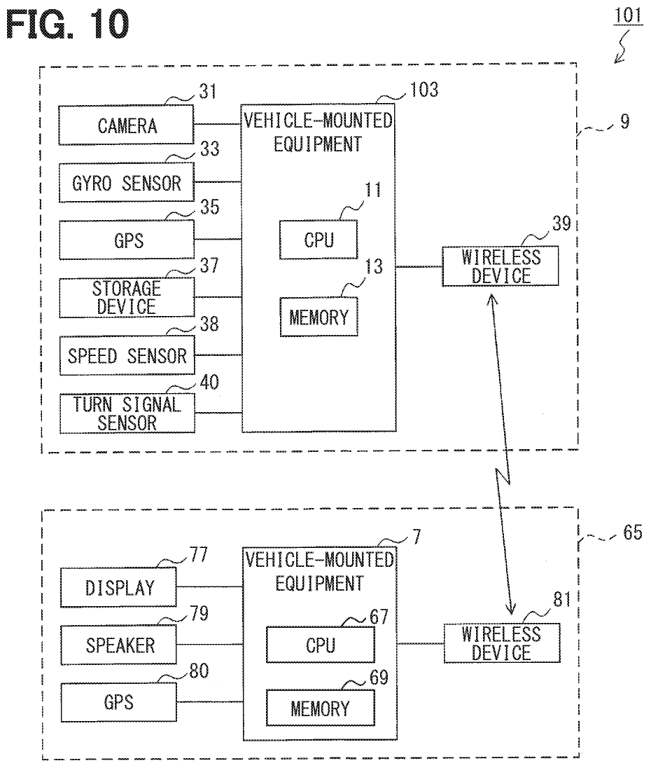

In the first embodiment described above, the notification system 1 includes the vehicle-mounted equipment 3 mounted in the first vehicle 9, the server 5 fixedly disposed, and the vehicle-mounted equipment 7 mounted in the second vehicle 65. By contrast, as illustrated in FIG. 10, a notification system 101 in the second embodiment includes vehicle-mounted equipment 103 mounted in the first vehicle 9 and the vehicle-mounted equipment 7 mounted in the second vehicle 65. The vehicle-mounted equipment 103 has respective functions of the vehicle-mounted equipment 3 and the server 5 in the first embodiment. The vehicle-mounted equipment 103 corresponds to the notification apparatus.

2. Process to be Performed by Vehicle-Mounted Equipment 103

The vehicle-mounted equipment 103 produces the first information, the second information, and the third information similarly to the vehicle-mounted equipment 3 in the first embodiment. The vehicle-mounted equipment 103 further produces the presence notification, the absence notification, and the first information similarly to the server 5 in the first embodiment and transmits the information items to the vehicle-mounted equipment 7 by vehicle-to-vehicle communication.

3. Effects Achieved by Vehicle-Mounted Equipment 103

According to the second embodiment described in detail heretofore, the effects (1A) to (1F) achieved in the first embodiment described above are achieved.

### Other Embodiments

While the embodiments of the present disclosure have been described heretofore, the present disclosure is not limited to the embodiments described above and can be variously modified to be implemented.

(1) A starting time of the image capture period may also be a time other than the first time ta. For example, any time within a period from the first time ta to the time tx can be set as the starting time of the image capture period. Also, an ending time of the image capture period may be a time other than the time ty. For example, any time within a period from the time tx to the second time tb can be set as the ending time of the image capture period.

(2) The camera 31 may also produce not a moving image, but still images at a plurality of times within the image capture period.

(3) The server 5 or the vehicle-mounted equipment 103 may also transmit the presence notification to the vehicle-mounted equipment 7 irrespective of whether or not the absolute position of the target object is within the driving prohibited area.

(4) The first position Pa, the position Px, the position Py, and the second position Pb may also be acquired using another method. For example, it may also be possible to acquire the first position Pa, the position Px, the position Py, and the second position Pb from a vehicular swept path of the first vehicle 9.

(5) In each of the embodiments described above, a plurality of functions of one component may be implemented by a plurality of components or one function of one component may be implemented by a plurality of components. Also, a plurality of functions of a plurality of components may be implemented by one component or one function implemented by a plurality of components may be implemented by one component. It may also be possible to omit a portion of a configuration in each of the embodiments described above. Alternatively, it may also be possible to add or substitute at least a portion of the configuration in each of the embodiments described above to or in a configuration in another of the embodiments described above.

(6) The present disclosure can be implemented not only as the notification apparatus described above, but also in various modes such as a system including the notification apparatus as a component, a program for causing a computer to function as the notification apparatus, a non-transitory tangible recording medium in which the program is recorded, such as a semiconductor memory, a notification method, and a drive assist method.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A notification apparatus comprising:
an image acquisition unit configured to acquire an image captured by a camera equipped in a first vehicle during an image capture period corresponding to at least a portion of a period between a first time at which the first vehicle begins to make a lane change from a first lane to a second lane and a second time at which the first vehicle finishes making the lane change from the second lane to the first lane;
a target object recognition unit configured to recognize a target object in the image acquired by the image acquisition unit; and
a notification unit configured to notify a second vehicle located behind the first vehicle of presence of the target object recognized by the target object recognition unit.

2. The notification apparatus according to claim 1, further comprising:
one or more processors; and
a memory coupled to the one or more processors and storing program instructions that when executed by the one or more processors cause the one or more processors to provide at least: the image acquisition unit, the target object recognition unit and the notification unit.

3. The notification apparatus according to claim 1, further comprising:
a vehicle information acquisition unit configured to acquire a position of the first vehicle and an azimuth angle of the first vehicle when the image is captured;
a relative position estimation unit configured to estimate a relative position of the target object recognized by the target object recognition unit based on the position of the first vehicle;
a target object position estimation unit configured to estimate a position of the target object in absolute coordinates based on the position of the first vehicle and the azimuth angle of the first vehicle acquired by the vehicle information acquisition unit and the relative position of the target object estimated by the relative position estimation unit;
a vehicle position acquisition unit configured to acquire a first position of the first vehicle at the first time and a second position of the first vehicle at the second time;
an area setting unit configured to set a driving prohibited area based on the first position and the second position acquired by the vehicle position acquisition unit; and
a target object determination unit configured to determine whether the position of the target object estimated by the target object position estimation unit is located within the driving prohibited area, wherein:
the notification unit is configured to notify the second vehicle of the presence of the target object on condition that the target object determination unit determines that the position of the target object estimated by the target object position estimation unit is located within the driving prohibited area.

4. The notification apparatus according to claim 1, further comprising:
a lane change detection unit configured to detect the lane change made by the first vehicle; and
a period setting unit configured to determine the first time based on a result of detection by the lane change detection unit and to set the image capture period beginning at the first time.

5. The notification apparatus according to claim 4, further comprising:
a deviation acquisition unit configured to acquire a deviation in a lateral direction between a center position in a current lane in which the first vehicle is disposed and the position of the first vehicle;
a lane keeping probability calculation unit configured to calculate a lane keeping probability as a probability that the first vehicle keeps the current lane, the lane keeping probability being higher as the deviation becomes smaller; and
an offset angle calculation unit configured to calculate an offset angle between the azimuth angle of the first vehicle and a travel direction of the lane in which the first vehicle is disposed, wherein:
the lane change detection unit is configured to detect that the first vehicle begins to make the lane change on condition that requirements of (J1) and (J2) are satisfied;
(J1) the lane keeping probability is equal to or lower than a predetermined threshold probability; and
(J2) the offset angle is equal to or larger than a predetermined threshold angle.

6. The notification apparatus according to claim 5, further comprising:
an information acquisition unit configured to acquire a type of a road around the first vehicle and a state of a turn signal in the first vehicle, wherein:
the lane change detection unit is configured to detect that the first vehicle begins to make the lane change on condition that requirements of (J3) and (J4) are satisfied in addition to the requirements of (J1) and (J2);
(J3) the road type acquired by the information acquisition unit is not an intersection; and
(J4) the state of the turn signal acquired by the information acquisition unit is an on state.

7. An in-vehicle device mounted in a mounting vehicle including a camera, the in-vehicle device comprising:
a lane change detection unit configured to detect a lane change made by the mounting vehicle; and
a transmission unit configured to transmit, to a server, an image captured by the camera during an image capture period corresponding to at least a portion of a period between a first time at which the mounting vehicle begins to make the lane change from a first lane to a second lane and a second time at which the mounting vehicle finishes making the lane change from the second lane to the first lane.

8. The in-vehicle device according to claim 7, further comprising:
one or more processors; and
a memory coupled to the one or more processors and storing program instructions that when executed by the one or more processors cause the one or more processors to provide at least: the lane change detection unit and the transmission unit.

9. The in-vehicle device according to claim 7, further comprising:
a parked state detection unit configured to detect that the mounting vehicle is parked as a parked vehicle on a road, wherein:
the transmission unit is configured to transmit, to the server, a parking state of the mounting vehicle as the parked vehicle on the road together with a position of the mounting vehicle.

10. An in-vehicle device mounted in a mounting vehicle, the in-vehicle device comprising:
an information reception unit configured to receive, via a server, information representing presence of a target object recognized by the server based on an image captured by a camera included in an other vehicle during an image capture period corresponding to at least a portion of a period between a first time at which the other vehicle begins to make a lane change from a first lane to a second lane and a second time at which the other vehicle finishes making the lane change from the second lane to the first lane; and
a control unit configured to control the mounting vehicle based on the information representing the presence of the target object.

11. The in-vehicle device according to claim 10, further comprising:
one or more processors; and
a memory coupled to the one or more processors and storing program instructions that when executed by the one or more processors cause the one or more processors to provide at least: the information reception unit and the control unit.
